(19) United States
(12) Patent Application Publication
(10) Pub. No.: US 2026/0240086 A1
(43) Pub. Date: Aug. 20, 2026

(54) SYSTEM AND METHOD FOR ANIMATING A PLANT

(71) Applicant: Hello Tomorrow, LLC, Pawtucket, RI (US)

(72) Inventors: Richard J. Maddocks, Barrington, RI (US); Leif J. Askeland, Greenville, RI (US)

(73) Assignee: Hello Tomorrow, LLC, Pawtucket, RI (US)

(21) Appl. No.: 19/419,039

(22) Filed: Dec. 14, 2025

Related U.S. Application Data
(60) Provisional application No. 63/741,496, filed on Jan. 3, 2025.

(51) Int. Cl. A01G 9/02; A01G 27/00; A01G 27/04

(52) U.S. Cl. CPC A01G 9/02; A01G 27/003; A01G 27/04

(57) ABSTRACT

A device and methods animating flowers or plants with responses from human user interaction and employing self-maintenance sensing such as watering techniques, and software or firmware artificial intelligence responsive modules, the disposed inner vessel having an underside including a pivoting magnet plate atop a waterproof interface relative to an outer plant pot lower housing. A self-watering wick assembly allows motive translation flexibly relative to the magnet interface while separating the waterproof interface. An electronic processor control module instantiates movement of the inner plant pot relative to the outer plant pot assembly via a single motor actuator, and a plurality of sensors in communication with the electronic processor control module collect data by the plurality of sensors upon the user touching the plant, among other inputs for interactive features, responses, or gameplay.

### FIELD OF THE INVENTION

The present invention relates to human interaction with live or artificial plants. Particularly, this invention relates to detecting human interaction with flowers or plants and triggering simulated responses from the live or artificial flowers and plants employing self-maintenance and sensing techniques with simulated plant response.

### BACKGROUND OF THE INVENTION

Human interest in plant care dates to the earliest recorded times. The rationale for human interest in plants varies from the need to grow own food and herbs to the urge to create beauty and to satisfy an artistic interest. Because plants, whether live or artificial, do not speak, at least not in a language perceptible by humans, it is easy for humans to forget to feed and water or otherwise nurture live plants in a way one would with pets. Growing strong healthy plants takes a certain amount of commitment. A need exists for a motorized yet waterproof electronic processor control that instantiates plant pot movements, with sensors in communication to collect data upon user interactions plants, including inputs for interactive features, and responses. The present invention is directed toward providing such methods, devices and systems.

### SUMMARY OF THE INVENTION

The methods and systems of the present invention provides an inner plant pot placed in a cooperative relationship with an outer pot. The inner pot interacts to enable the plant and pot assembly to move longitude (or nod/tilt forward and back) as well as rotating side to side.

The present invention advances the art of plant nurturing for human interaction with plants. An electronic processor control module instantiates movement of the inner plant pot relative to the outer plant pot assembly via a waterproof interface with magnetic attraction with rotational, tilt and pivot magnet interactions, and a plurality of sensors in communication with the electronic processor control module collect data by the plurality of sensors upon the user touching the plant, among other inputs for interactive features, responses, gameplay, and the like.

Briefly summarized, the present inventions relate to with flowers or plants triggering simulated responses from human user interaction where flowers and plants employ self-maintenance sensing such as watering techniques, and software or firmware artificial intelligence responsive modules, while disposed as supporting and animating the flower or plant in an inner vessel having an underside including a pivoting magnet plate atop a waterproof interface relative to an outer plant pot lower housing. A follower magnet is mounted using a cam follower positioned below the waterproof interface for magnetic attraction with the pivoting magnet plate above. An electronic processor control module instantiates movement of the inner plant pot relative to the outer plant pot assembly via a single motor actuator. A waterproof lower housing is provided by means of magnetic couplings to protect the electronic components, sensors, speaker, motor, power supply battery box from water intrusion during watering of the plant, to prevent water entering the lower housing causing a malfunction and permanent damage in the event of a user overfilling the inner pot during the normal course of plant maintenance. The design also facilitates ease of removal of inner pot for cleaning by simply lifting out of outer pot by breaking the magnetic attraction. The functionality and benefits provided by the present invention will be apparent to those skilled in the art from the description that follows.

### BRIEF DESCRIPTION OF DRAWINGS

For the purpose of facilitating an understanding of the invention, the accompanying drawings and detailed description illustrate preferred embodiments thereof, from which the invention, its structures, its constructions and operations, its processes, and many related advantages may be readily understood and appreciated.

FIGS. 1 and 2 are illustrative perspective views showing elements of the present invention embodied as a standard round nursery plant pot 4 containing a plant rooted in potting soil purchased from point of sale about to be inserted into the inner pot with probe for monitoring the moisture level inserted into the potting soil;

FIGS. 3A through 3C are exploded perspective views with part section superimposed through the upper and lower pots showing a rotating turntable disposed using magnetic attraction with the pivoting magnet plate for inner plant pot movements relative to the outer plant pot assembly, where inset FIG. 3D shows a wick assembly self-watering element therethrough a radial tube to a reservoir with motive translation flexibly accommodates movements and the human user interaction allowing animation through the waterproof interface;

FIG. 4 is a sectional view through the plant pot assembly illustrating the tilt actuation with the drive mechanism, magnetic coupling and waterproof interface assembly;

FIG. 5 shows magnetic coupling with magnet orientation indicated by south pole ‘S’ and north pole ‘N’ aligned to transmit tilt and turn motion through the waterproof interface;

FIGS. 6 and 7 illustrate the self-watering element wick assembly through a radial tube to a reservoir with motive translation flexibly accommodates movements and the human user interaction allowing animation through the waterproof interface enabling independent turn and tilt actuation;

FIG. 8 is a perspective view showing the inner vessel or pot disposed atop a rotating turntable for inner plant pot movements, including the wick assembly self-watering element extending to the reservoir with motive translation flexibly that accommodates movements allowing animation interactions;

FIGS. 9 and 10 are side views of a described embodiment with the tilt mechanism showing plant in FIG. 9 in its upright position, then in a leaning back position in FIG. 10 for upright, forward and back responses with the plant in tilting positions through possible cam profile configurations;

FIGS. 11, 12 and 13 are plant 5 front views of the present described embodiment with the turntable rotating from its center facing forward or neutral position, then right with turntable shown rotated to turned right position, and left with turntable shown rotated to turned left position respectively;

FIG. 14 depicts an illustrative example of the hardware, firmware, and software architecture including an artificial intelligence (AI) processor module in accordance with the present inventions; and

FIGS. 15A through 15E are illustrative flow charts illustrating operations in accordance with the present inventions.

### DETAILED DESCRIPTION OF THE EMBODIMENTS

The present invention is generally directed to a device and methods animating flowers or plants with responses from human user interaction and employing self-maintenance sensing such as watering techniques, and software or firmware artificial intelligence responsive modules, the disposed inner vessel having an underside including a pivoting magnet plate atop a waterproof interface relative to an outer plant pot lower housing. A follower magnet is mounted using a cam follower positioned below the waterproof interface for magnetic attraction with the pivoting magnet plate above. An electronic processor control module instantiates movement of the inner plant pot relative to the outer plant pot assembly via a single motor actuator, and a plurality of sensors in communication with the electronic processor control module collect data by the plurality of sensors upon the user touching the plant, among other inputs for interactive features, responses, gameplay, and the like. To this end, Applicants U.S. Pat. Nos. 10,966,550, and 12,156,499 for System and Method for Animating a Plant disclosures are hereby incorporated by reference in their entirety herein.

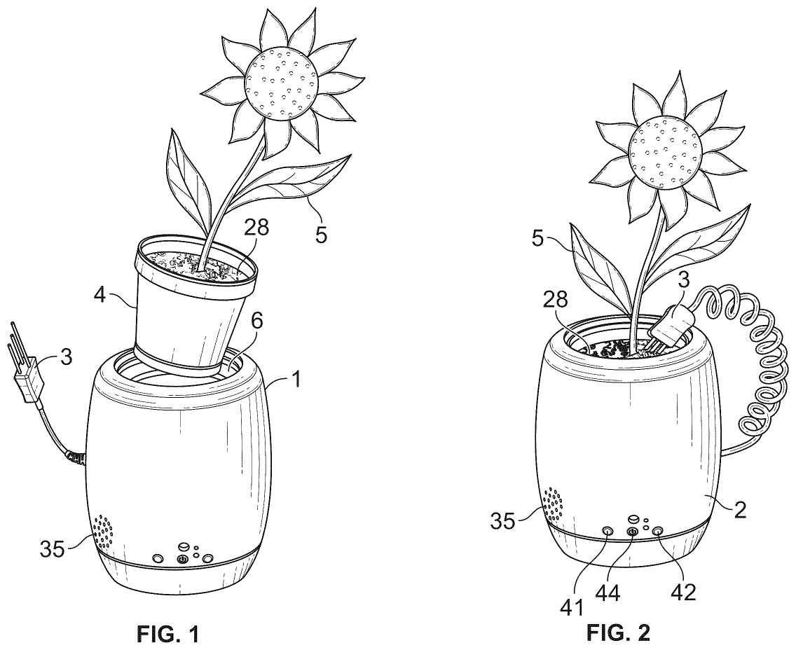

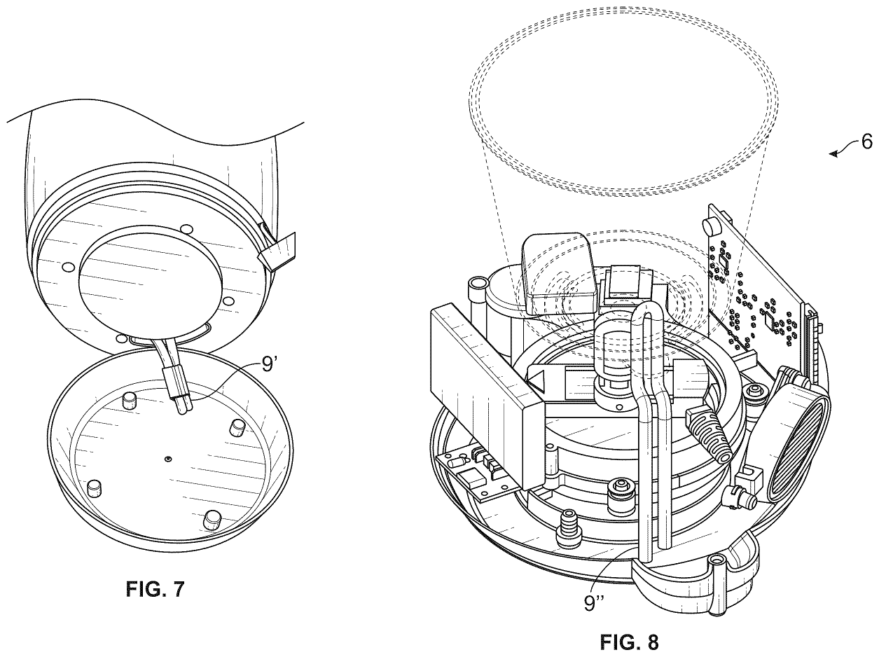

FIGS. 1 through 15E, exemplary embodiments of improved operation for animating a plant with an inner plant pot having an underside including a pivoting magnet plate atop a waterproof interface relative to an outer plant pot lower housing. A follower magnet is mounted using a cam follower positioned below the waterproof interface for magnetic attraction with the pivoting magnet plate above. An electronic processor control module instantiates movement of the inner plant pot relative to the outer plant pot assembly via a single motor actuator. A waterproof lower housing is provided by means of magnetic couplings to protect the electronic components, sensors, speaker, motor, batteries and power supply from water intrusion during the normal course of plant maintenance. This design also allows a standard round nursery plant pot obtained from point of purchase, containing a plant, to be inserted into the inner pot without having to re-plant. The system 70 below enables human users to communicate with live plants using natural language. The use of natural language can be used to support the plant's physiological needs as well as to provide companionship and entertainment with a live plant in essence mimicking human to human companionship. As a container designed to house a conventional live plant, further provided mechanism and circuitry elements enable the plant to move within the confines of the container. The container may include a microphone and circuitry suitable to accept human language input and process these to extract and identify human commands and for the plant to deliver meaningful audio and movement responses from a library of predetermined responses. An alternative embodiment may provide a simple module with no moving mechanical elements, which may be inserted into any generic planter or container. Additionally, such alternatives can support the plant's physiological needs and provide meaningful responses to human interaction. Furthermore, disclosed features may be embedded into large arrays of plants. A large, mounted arraignment of plants on walls advantageously provide beauty and a sense of wellbeing. These arrays of plants can be animated in a synchronized manner. In response to human verbal commands the plants may be able to provide music, song, and dance moves in synchronicity. In addition, modules may be placed outdoors adjacent to existing shrubs and flowers thereby making the plant appear to speak to humans as they pass by. Furthermore, disclosed features may be facilitated into applications running a smart device may be linked to further enhance interactivity and plant nurturing, for example:
A. Word recognition to respond to key words, further with renaming function, and use of the name as individual plant trigger word functions;
B. Addition of an App to enable remote updates to a message delivered by touch, custom revisions to content, access to online plant care, extensions;
C. Compatibility with smart home environments including recognition by Siri™ or Alexa™; or
D. Multiple units synchronized to ‘perform’ together with sound and movement.

The described embodiment allows for easy removal of inner pot 6 for cleaning by simply lifting out of outer pot upper 1 by breaking the magnetic attraction. A drain or wick 9 with water reservoir is incorporated into mechanism and waterproof housing and discussed herein, and current moisture detection feature with a bubbly sound when the soil is dry will still alert the user when the reservoir is dry and needs refilling.

FIGS. 1 and 2 show a standard round nursery plant pot 4 containing a plant 5 rooted in potting soil 28 purchased from point of sale about to be inserted into the inner pot 6 with probe 3 for monitoring the moisture level inserted into the potting soil 28. An outer plant pot assembly includes an outer pot upper housing 1 and an outer pot lower housing 2, the outer pot upper housing 1 defines a first outer plant pot interior volume and a waterproof interface 7, the outer pot lower housing 2 defines a second outer plant pot interior volume.

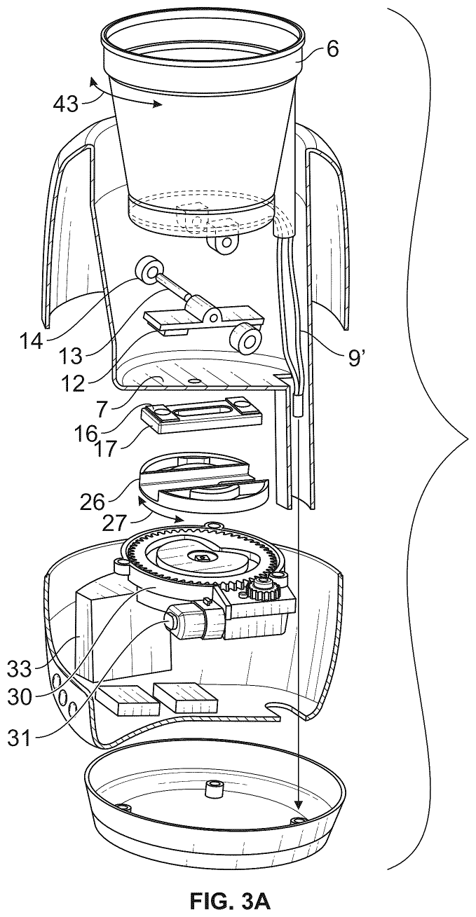

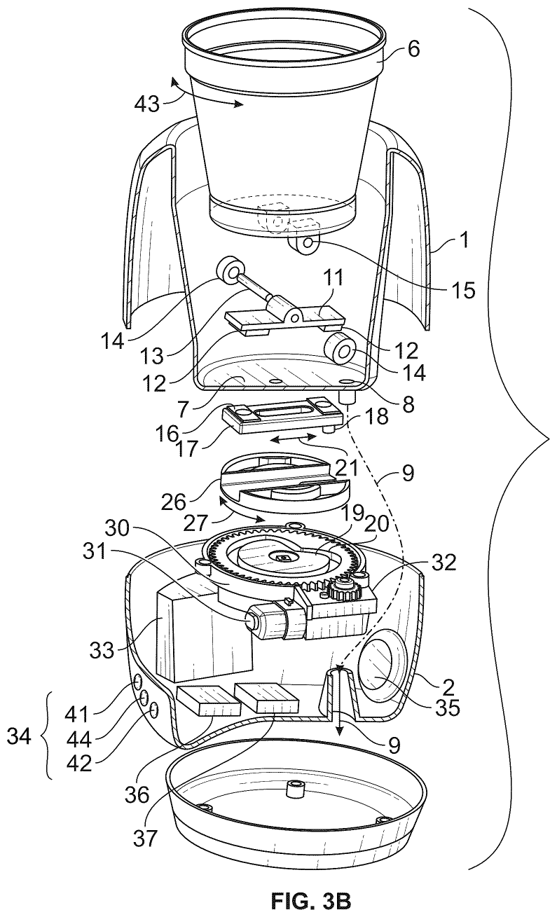

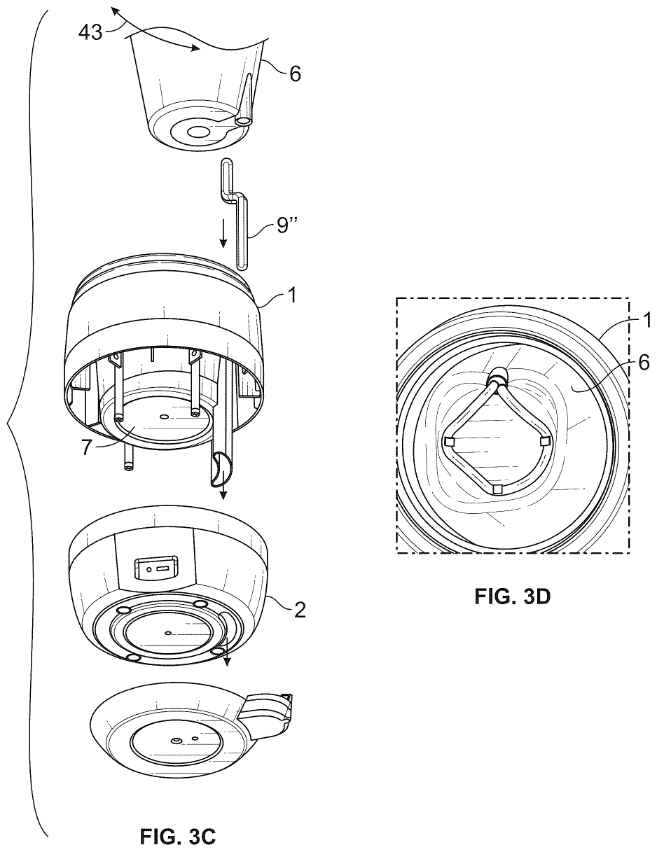

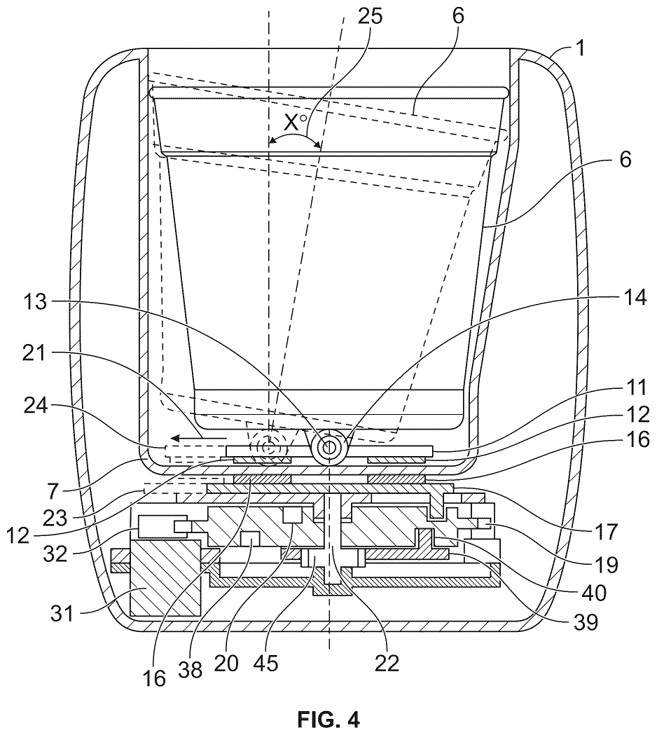

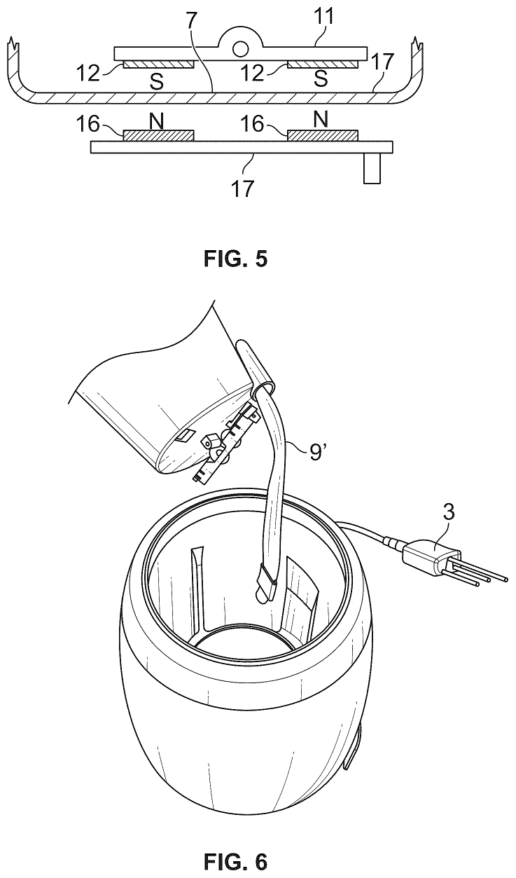

A cam mechanism (double sided cam 19) and cam follower (tilt cam follower 17/tilt cam follower peg 18) are disposed within the second outer plant pot interior volume, the cam mechanism actuated with a motor module 31 and motor/reduction gearing/cam sub-assembly 30. FIGS. 3A and 3B exploded perspective view with part section through the upper and lower pots showing a rotating turntable 26 is disposed between follower magnet and the cam mechanism with a turntable shaft 22 connected therethrough with the motor actuator for transmitting bi-directional movements using the cam follower 17 and follower magnet magnetic attraction with the pivoting magnet plate 11 for inner plant pot movements relative to the outer plant pot assembly, which causes a resulting animation by the cam follower mechanism through the waterproof interface, with part section through the upper and lower pots showing the magnetic clutch and waterproof interface. FIG. 4 is a sectional view through the plant pot assembly illustrating the tilt actuation with the drive mechanism, magnetic coupling and waterproof interface assembly. In FIG. 5 magnetic coupling via magnet orientation indicated by south pole ‘S’ and north pole ‘N’ is aligned to transmit tilt and turn motion through the waterproof interface. Referring to FIG. 1 a standard round nursery plant pot 4 containing a plant 5 rooted in potting soil 28 purchased from point of sale about to be inserted into the inner pot 6. Referring to FIGS. 3A-3C a drain and/or wick path 9 accommodates wick 9′ or 9″ and connects outer pot drain 8 to drain exit 10 allowing any excess water to drain out through the drain exit 10 in waterproof interface 7. A radial tube, e.g., FIGS. 3C, 6 and 7 connects the upper housing 1 with the lower housing 2 to the reservoir, allowing the wick 9″ extensions free movement to rotate with the inner pot while still immersed in the water contained in the reservoir. A wick assembly self-watering element of FIG. 3D therethrough to reservoir to draw water therefrom, while allowing wick motive translation flexibly that accommodates movements and animation. FIGS. 3C, 6 and 7 illustrate the self-watering element wick 9′, 9″ assemblies through the radial tube to a reservoir with motive translation flexibly accommodates movements and the human user interaction allowing animation through the waterproof interface enabling independent turn and tilt actuation. The wick 9′ from inner pot from the reservoir is maintained through path 9 apart in relation to waterproof area in lower housing for the electronics. FIG. 8 is a perspective view showing the inner vessel or pot disposed atop a rotating turntable for inner plant pot movements, including the wick 9″ assembly self-watering element extending to the reservoir with motive translation flexibly that accommodates movements allowing animation interactions.

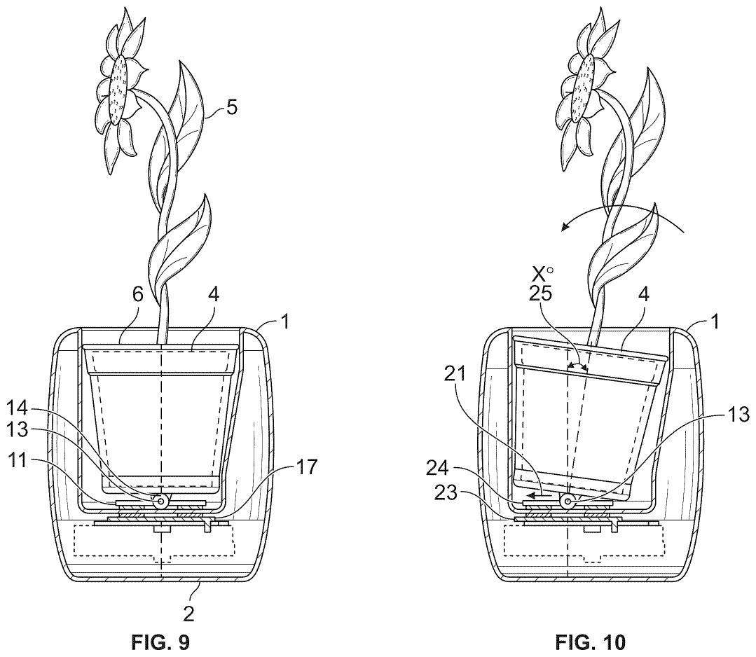

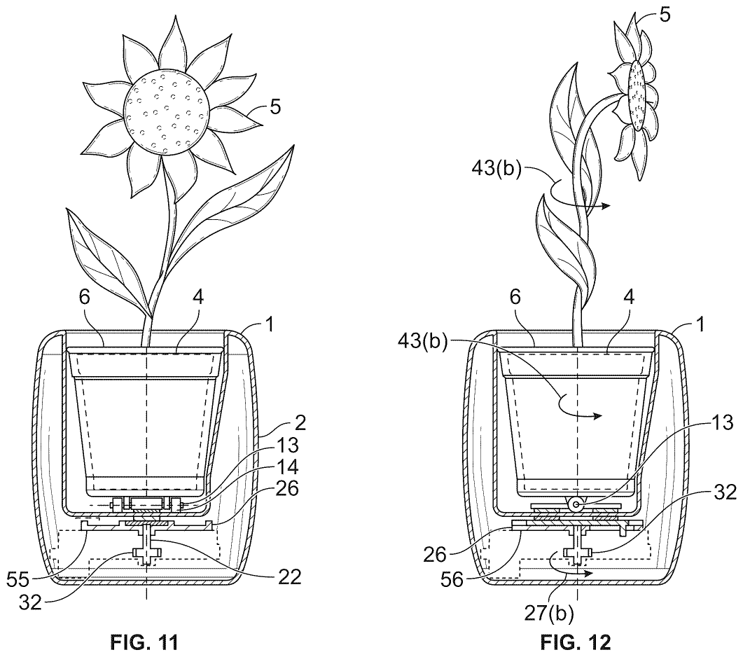

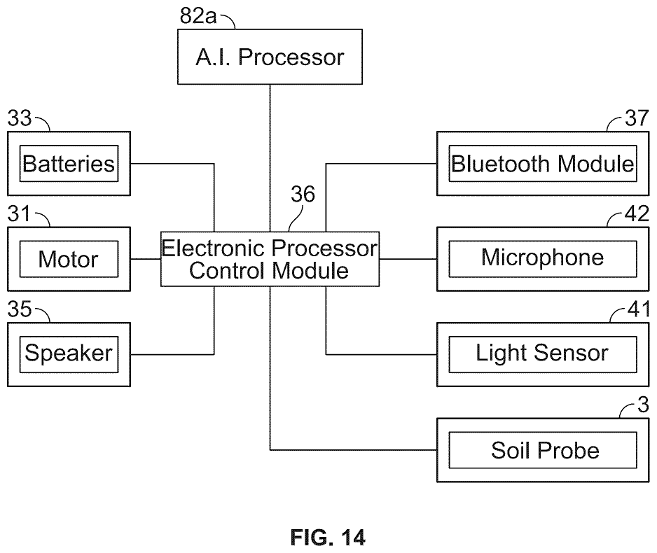

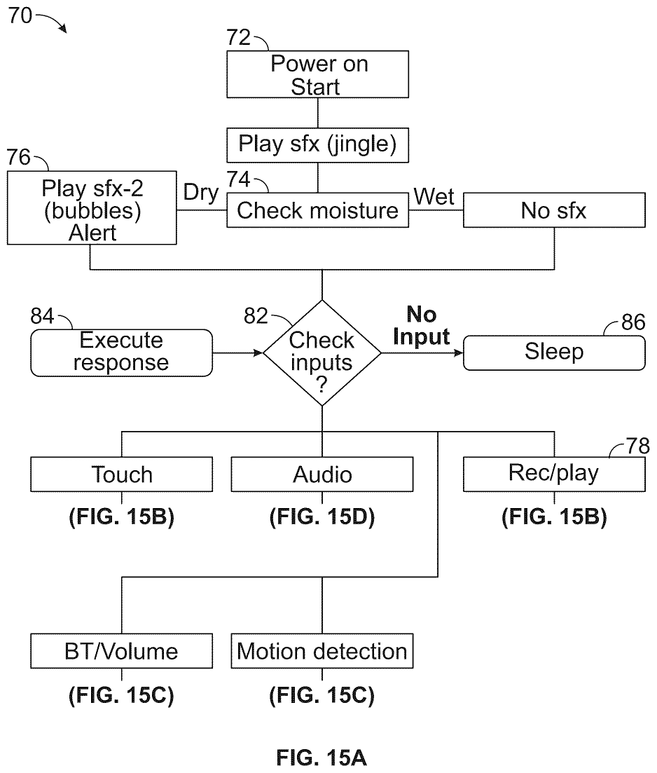

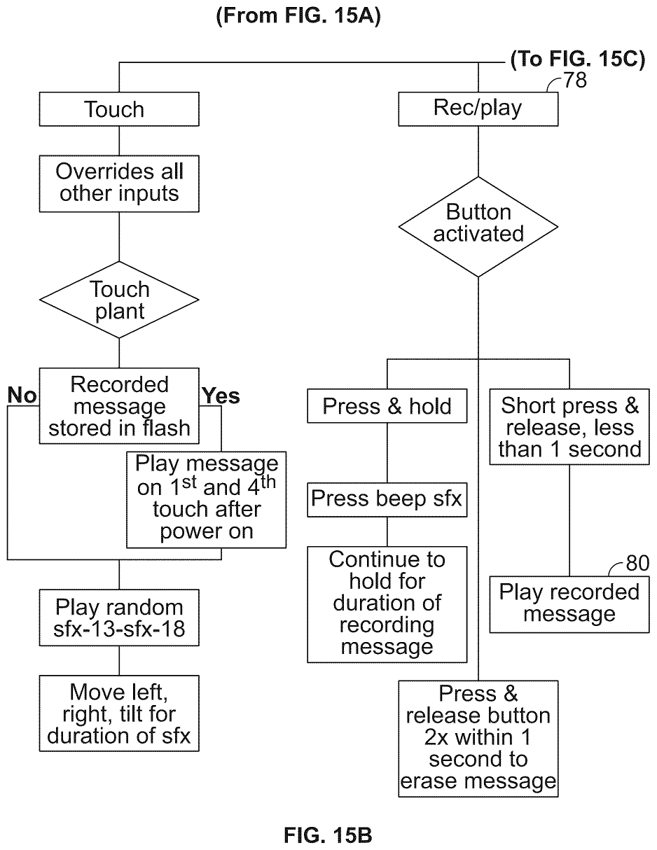

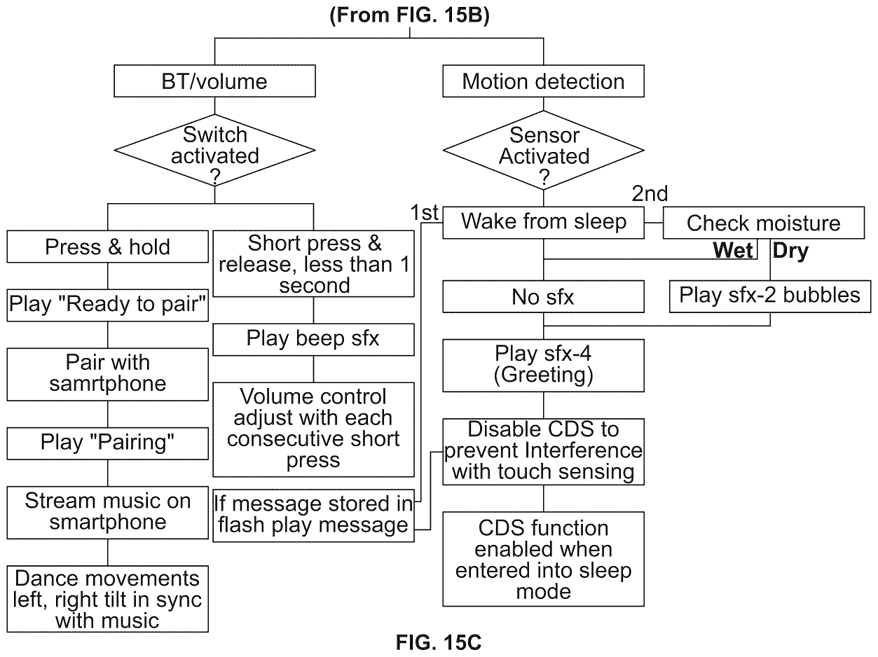

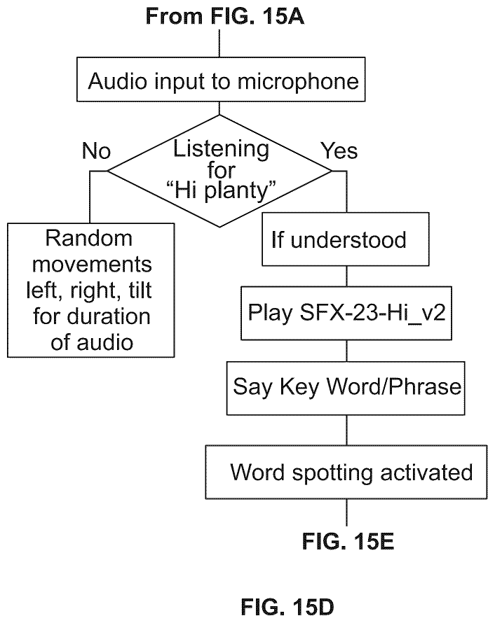

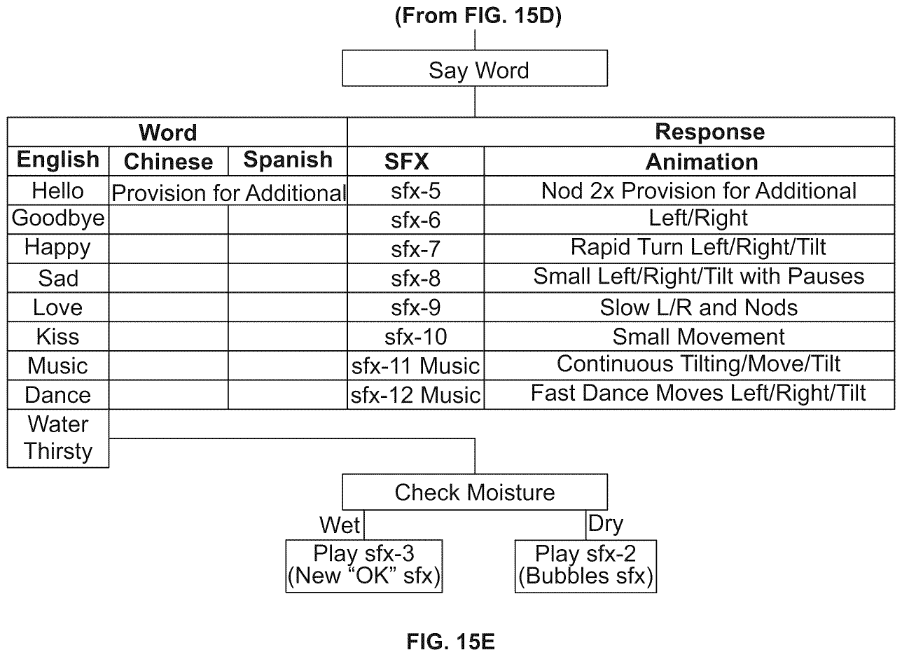

FIGS. 9 and 10 are side views of a described embodiment with the tilt mechanism showing plant 5 in FIG. 9 in its upright position, then in a leaning back position in FIG. 10 for upright, forward and back responses with the plant in tilting positions through possible cam profile configurations. FIGS. 11, 12 and 13 are plant 5 front views of the present described embodiment with the turntable 26 rotating from its center facing forward or neutral position 55, then right with turntable 26 shown rotated to turned right position 56 and left with turntable 26 shown rotated to turned left position 57 respectively. As described further below, FIG. 14 depicts an illustrative example of the hardware architecture utilized, and FIG. 15 provides an illustrative flow chart for operations in accordance with the embodiments.

Referring again to FIG. 2 the probe 3 is inserted into potting soil 28 to enable connectivity completing the circuit indicated in FIG. 15A to enable human interaction with the plant by touch. Also, to measure the moisture level in the potting soil 28 alerting the user with audio message 80 to add water if the potting soil is too dry.

When power is switched on at start 72 the Electronic Processor Module 36 will continuously check for inputs from sensor array 34. The system 70 is responsive to sensed human user audio, touch and movement, such as proximity alert for low moisture or audible interaction. such as movement; embodiments (self-watering AI, and natural language, or word spotting. The AI Processor 82a, and Check Inputs 82 as described include:
1. Measure moisture content in potting soil 28 enabled with connection to probe 3
2. Proximity detection from CDS light sensor 41
3. Human touch on plant 5 detected by capacitive sensing enabled through connection to probe 3 in potting soil 28
4. Audio input (voice or music) from microphone 42
5. Bluetooth module 37 pairing from smartphone.

Referring to FIG. 14, FIGS. 15A through 15E operations, with corresponding Execute Response 84:
1. Play audio alert warning that potting soil 28 is dry and water is required
2. Enabled by animated inner pot 6 the plant 5 will respond with preprogrammed movement routines such as greeting gesture with sound effects.
3. Enabled by animated inner pot 6 the plant 5 will respond with preprogrammed movement routines such as demonstrating affection with sound effects.
4. Enabled by animated inner pot 6 the plant 5 will react with preprogrammed movement routines such as synchronized dancing to music or responding to conversation.
5. All audio content (voice and music) from the paired smartphone will be played back through the speaker 35 in outer pot 2, accompanied with synchronized dance moves by the plant 5 enabled by animated inner pot 6.

With reference to FIGS. 1, 14, 15A-15E, the audio message 80 is stored in flash memory in the Electronic Processor Module 36. The user records a customized personal message 78 by pressing and holding the message button 44 while speaking onto microphone 42. Record a Message: 1) Press and hold the Record Button (REC/PLAY). 2) When you hear a beep start recording a message, speaking closely into the microphone. Continue to hold the (REC/PLAY) button for the duration of your message. 3) Press and release the (REC/PLAY) button to play back your message. Repeat steps 1 and 2 to re-record. 4) Turn system 70 off/turn the power back on and your message will play when the Proximity Sensor is activated. Touch your plant's leaves or stem and the message will play back once more; at any time press and release the (REC/PLAY) button to play back your message. Surface mounted capacitive switches replace the control panel and message button 44.

(Check Inputs 82)—On the first touch of the plant 5 or by pressing and releasing the message button 44 the audio message is played back by the recipient (Execute response 84). Such sensors and response are not limited to these examples as inputs and responses
Power On/Touch plant activate; TOUCH Sensor activated;
BT/VOLUME: Play sfx (Sound Effect “sfx” e.g. Jingle); Play random sfx-13-sfx-18; Play sfx-2 (Bubbles); Check moisture, continue to:
MOTION DETECTION—When waking up from sleep—will play bubbly sfx if it needs water. This is automatic, as is ‘check moisture’ at Power On.
AI MODE—
TOUCH:
Move left, right, tilt for duration of sfx;
Play “Ready to pair”;
Play beep sfx;
REC/PLAY Button activated—Press & hold;
Play beep sfx;
Wake from sleep;
Pair with smartphone—
Dance movements left, right tilt in sync with music;
If message stored in flash Play message: MUSIC MODE (Default);
Random movements left, right, tilt for duration of audio;
AUDIO—
Play “Pairing”;
Stream music on smartphone.

Referring to FIGS. 3A, 3B, 4 and 5, magnets 12 and 16 are mounted in the respective assemblies such that they attract through the waterproof interface 7 thereby transmitting the turn and tilt motion to the inner pot 6. To enable the described attraction, referring to FIG. 5 magnets 16 are mounted with north pole (N) face up in tilt cam follower 17. Magnets 12 mounted with south pole (S) face down in pivoting magnet plate 11. The self-watering wick 9′ assembly allows motive translation flexibly relative to the magnet interface while separating the waterproof interface. FIG. 3C and FIG. 8 are exploded and perspective views respectively with part section superimposed through the upper and lower pots facilitating its rotating turntable disposed using magnetic attraction with the pivoting magnet plate for inner plant pot movements relative to the outer plant pot assembly, where inset FIG. 3D shows the wick 9′ assembly self-watering element therethrough the radial tube to the reservoir with motive translation flexibly accommodates rotating, movements and the human user interaction allowing animation through the waterproof interface.

As shown, rollers 14 are mounted on dual purpose shaft 13 enable the pivoting magnet plate 11 to maintain close parallel contact with the waterproof interface 7 to maximize the magnetic attraction. Additionally rollers 14 provide a low friction bearing support for the inner pot 6 as it pivots through X °tilt 25 and rotates in direction of arrow 43 when actuated by rotation of turntable 26 as indicated by arrow 27. Referring to FIGS. 3A and 3B, the single motor module 31 with the output drive gear 32 engages with gear teeth on the periphery of double sided cam 19 to drive the cam 19 clockwise or counterclockwise, controlled by the electronic processor control module 36. Referring to FIGS. 4 and 5 when the tilt cam follower 17 moves to position 23 magnets 16 attract magnets 12 moving the pivoting magnet plate 11 to position 24 as indicated by tilt actuation arrow 21 causing the inner pot 6 to tilt through X °tilt rotation 25.

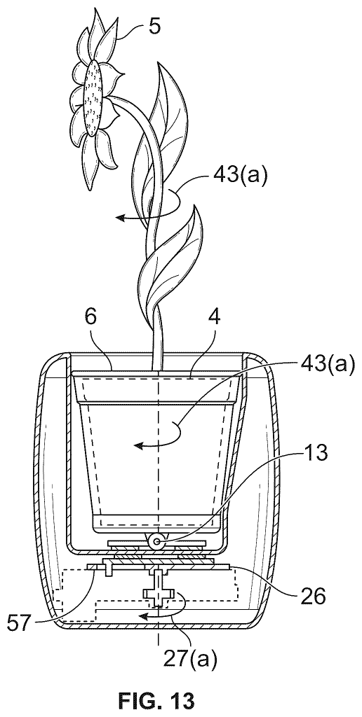

FIG. 12 demonstrates turntable 26 direction of rotation counter-clockwise 27(b), the rotation 43(b) transmitted to inner pot 6 by means of magnetic coupling (FIG. 5) resulting in plant 5 turned right position. Bi-directional rotational movement is transmitted through turntable shaft 22 rigidly connected to rotating turntable 26 by square plug and socket as indicated by rotation arrow 27, also indicated in FIGS. 12 and 13. FIG. 13 demonstrates turntable 26 direction of rotation clockwise 27(a), the rotation 43(a) transmitted to inner pot 6 by means of magnetic coupling (FIG. 5) resulting in plant 5 turned left position.

A “nodding gesture or bowing” animation is achieved by rotating cam profile 29 counterclockwise from initial position (FIG. 10) to position 48 (FIG. 9), then reversing motor to rotate its cam profile back to initial position (FIG. 10). The resulting animation, e.g., a tilt forward and back as shown in FIGS. 9 and 10. As exemplary positions and movements (facing forward ref FIG. 11) to position (turned right position, ref FIG. 12), continuing clockwise, (turned left position FIG. 13). To continue clockwise a constantly increasing radius to position returns the inner pot 6 to facing forward position in FIG. 11.

Referring again to FIGS. 14 through 15E respective block diagram/flow chart use capacitive sensing ability of the leaves wakes up the computer chip to unlock a preprogrammed sequence of animated routines including but not limited to the speed of stroking and touching, unlocking a musical sequence, initiating dance like movements, etc. In accordance with aspects of the embodiments, the plant leaf can serve as the capacitance sensor, such that when a person touches a leaf a circuit is completed with conductivity via a remote soil probe 3 that is placed in the soil. Talking to the plant will also initiate a response by input to a microphone, as will playing music or clapping hands when the plant will simulate dance moves in response to the incoming sounds.
AI MODE/WORD RESPONSE: Word spotting activated: E.g. Water—Thirsty
Play sfx-2 (e.g., Bubbles sfx; “PlantPetz™” is the default trigger word)
ENGLISH/CHINESE/SPANISH: SFX & ANIMATION:
Response with movement and Greeting sfx/Continue for the other word spotting words either singly or in a sentence:
Hello—sfx-5 Nod 2x
Goodbye—Sfx-6 Left/right
Happy—Sfx-7Rapid Turn left/right/tilt
Sad—Sfx-8 Small left/right/tilt with pauses
Love—Sfx-9 Slow L/R and nods
Kiss—Sfx-10 Small movement
Music—
Sfx-11 Music Continuous Tilting/move/tilt—Plays Music With continuous tilting movements in sync;
Dance
Sfx-12 music Fast dance moves left/right/tilt-Dance movements left/right/tilt accompanied by music;
RENAMING, see FIG. 15E, Referring to Renaming procedure:
1. Press and hold Power Button for 3 seconds to rename Plant (“PlantPetz™” is the default trigger word)
2. You will hear “Say new name now”
3. Say new name into the microphone
4. You will hear “Please wait”
5. You will hear “Renaming successful”
Now Plant will respond to the new name as the new trigger word.

Numerous modifications and alternative embodiments of the present inventions will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. As utilized herein, the terms “comprises” and “comprising” are intended to be construed as being inclusive, not exclusive. The use of “substantially” is equally applicable when utilized in a negative connotation to refer to the complete or near complete lack of an action, characteristic, property, state, structure, item, or result, as would be appreciated by one of skill in the art. As utilized herein, the terms “about”, “generally”, and “approximately” are intended to cover variations. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

From the foregoing, it can be seen that there has been provided a detailed description and features for improved apparatus and methods as well as a disclosure of a method for assembling the game apparatus. While a particular embodiment of the present invention have been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustrations only, and not as limitations. The actual scope of the invention is to be defined by the subsequent claims when viewed in their proper perspective based on the prior art.

What is claimed is:

1. A device for supporting and animating flowers or plants, comprising:
an outer plant pot assembly comprising an outer pot upper housing and an outer pot lower housing, the outer pot upper housing defining a first outer plant pot interior volume and a waterproof interface, the outer pot lower housing defining a second outer plant pot interior volume with the waterproof interface disposed between the first outer plant pot interior volume and the second outer plant pot interior volume;
an inner plant pot having an inner plant pot interior volume configured to house a plant therein with the inner plant pot received within the first outer plant pot interior volume, the inner plant pot having an underside thereof coupled with a pivoting magnet plate at the waterproof interface for inner plant pot displacement movements relative to the first outer plant pot interior volume and the waterproof interface, the outer pot lower housing defining a second outer plant pot interior volume;
a motor actuator within the second outer plant pot interior volume, the disposed inner vessel having an underside including a pivoting magnet plate atop a waterproof interface relative to an outer plant pot lower housing;
an electronic processor control module for movement of the inner plant pot relative to the outer plant pot assembly animated with the motor actuator, including a plurality of sensors in communication with the electronic processor control module to collect data including human user interaction; and
an artificial intelligence responsive software or firmware module and employing self-maintenance sensing including a self-watering element responsive to sensed human user movements or audible interaction.

2. The plant supporting and animating device of claim 1, wherein the self-watering element comprises a wick assembly through a radial tube to a reservoir with motive translation flexibly accommodating movements and the human user interaction.

3. The plant supporting and animating device of claim 1, wherein the motor actuator controls and instantiates vertical longitudinal movement of the inner plant pot relative to the outer plant pot assembly.

4. The plant supporting and animating device of claim 1, wherein the motor actuator controls and instantiates rotational movement of the inner plant pot relative to the outer plant pot assembly.

5. The plant supporting and animating device of claim 1, further comprising an electronic processor control module that instantiates movement of the inner plant pot relative to the outer plant pot assembly with the motor actuator.

6. The plant supporting and animating device of claim 5, further comprising a plurality of sensors in communication with the electronic processor control module providing data collected by the plurality of sensors.

7. The plant supporting and animating device of claim 6, wherein the plurality of sensors comprise one or more of a capacitance sensor, an audio sensor, an optical sensor, a vibrational sensor, a moisture sensor, a temperature sensor, a magnetic sensor, a chemical sensor, a motion sensor, an infrared sensor, and a wireless electromagnetic signal sensor.

8. The plant supporting and animating device of claim 6, wherein at least one of the plurality of sensors comprises a capacitance sensor.

9. The plant supporting and animating device of claim 8, wherein the plurality of sensors comprise a soil probe, the capacitance sensor comprises a leaf of a plant, and a conductive circuit is completed when a user touches the leaf and the conductivity circuit is completed via the soil probe, which provides capacitance data that changes upon the user touching the plant.

10. The plant supporting and animating device of claim 5, further comprising a soil probe disposed within the inner pot interior volume, the soil probe enabling electronic communication between the electronic processor control module and a plurality of sensors, wherein an electronic processor controller comprises a means to communicate with smart devices using electromagnetic waves.

11. The plant supporting and animating device of claim 2, comprising a rotating turntable disposed between follower magnet and the cam mechanism with a turntable shaft connected therethrough with the motor actuator for transmitting bi-directional movements using the cam follower and follower magnet magnetic attraction with the pivoting magnet plate for inner plant pot movements relative to the outer plant pot assembly, which causes a resulting animation of the inner plant pot.

12. The plant supporting and animating device of claim 11, wherein the follower magnet, comprises a magnetic coupling with south pole and north pole magnet orientation with the pivoting magnet plate for tilt and turn inner plant pot movements of the inner plant pot relative to the outer plant pot using the cam follower.

13. A method for supporting and animating flowers or plants, comprising:
providing an outer plant pot assembly with an outer pot upper housing and an outer pot lower housing;
defining a first outer plant pot interior volume in the outer pot upper housing;
defining a second outer plant pot interior volume in the outer pot lower housing;
providing a waterproof interface disposed between the first outer plant pot interior volume and the second outer plant pot interior volume;
providing an inner plant pot having an inner plant pot interior volume configured to house a plant therein with the inner plant pot received within the first outer plant pot interior volume;
coupling an underside of the inner plant pot with a pivoting magnet plate at the waterproof interface for inner plant pot displacement movements relative to the first outer plant pot interior volume at the waterproof interface above the second outer plant pot interior volume of the outer pot lower housing;
positioning a single motor actuator within the second outer plant pot interior volume, the disposed inner vessel having an underside including a pivoting magnet plate atop a waterproof interface relative to an outer plant pot lower housing;
providing an electronic processor control module for movement of the inner plant pot relative to the outer plant pot assembly animated with the motor actuator, including a plurality of sensors in communication with the electronic processor control module to collect data including human user interaction; and
employing self-maintenance artificial intelligence sensing including a self-watering element responsive to sensed human user movements or audible interaction.

14. The plant supporting and animating method of claim 13, wherein the motor actuator and the cam mechanism are mounted together within the second outer plant pot interior volume.

15. The plant supporting and animating method of claim 13, further comprising the step of providing a rotating turntable disposed between follower magnet and the cam mechanism with a turntable shaft connected therethrough with the motor actuator for transmitting bi-directional movements using the cam follower and follower magnet magnetic attraction with the pivoting magnet plate for inner plant pot movements relative to the outer plant pot assembly, which causes a resulting animation of the inner plant pot.

16. The plant supporting and animating device of method 13, wherein the motor actuator controls and instantiates rotational movement of the inner plant pot relative to the outer plant pot.

17. The plant supporting and animating device of method 13, further comprising the step of providing an electronic processor control module that instantiates movement of the inner plant pot relative to the outer plant pot with the motor actuator.

18. A system for supporting and animating flowers or plants, comprising:
an outer plant pot assembly comprising an outer pot upper housing and an outer pot lower housing, the outer pot upper housing defining a first outer plant pot interior volume and a waterproof interface, the outer pot lower housing defining a second outer plant pot interior volume with the waterproof interface disposed between the first outer plant pot interior volume and the second outer plant pot interior volume;
an inner plant pot having an inner plant pot interior volume configured to house a plant therein with the inner plant pot received within the first outer plant pot interior volume, the inner plant pot having an underside thereof coupled with a pivoting magnet plate at the waterproof interface for inner plant pot displacement movements relative to the first outer plant pot interior volume and the waterproof interface, the outer pot lower housing defining a second outer plant pot interior volume;
a motor actuator within the second outer plant pot interior volume, the disposed inner vessel having an underside including a pivoting magnet plate atop a waterproof interface relative to an outer plant pot lower housing;
an electronic processor control module for movement of the inner plant pot relative to the outer plant pot assembly animated with the motor actuator, including a plurality of sensors in communication with the electronic processor control module to collect data including human user interaction;
an artificial intelligence responsive software or firmware module and employing self-maintenance sensing; and
a self-watering wick assembly with motive translation flexibly responsive to sensed human user movements or audible interaction.

19. The plant supporting and animating system of claim 18, wherein at least one of the plurality of sensors comprises a capacitance sensor.

20. The plant supporting and animating system of claim 19, wherein the plurality of sensors comprise a soil probe, the capacitance sensor comprises a leaf of a plant, and a conductive circuit is completed when a user touches the leaf and the conductivity circuit is completed via the soil probe, which provides capacitance data that changes upon the user touching the plant.
